(19) United States
(12) Patent Application Publication
(10) Pub. No.: US 2015/0287521 A1
(43) Pub. Date: Oct. 8, 2015

(54) COIL FIXATION STRUCTURE

(71) Applicant: YAZAKI CORPORATION, Tokyo (JP)

(72) Inventors: Shouichi FURUKAWA, Shizuoka (JP); Isao KAMEYAMA, Shizuoka (JP)

(21) Appl. No.: 14/675,830

(22) Filed: Apr. 1, 2015

(30) Foreign Application Priority Data
Apr. 4, 2014 (JP) 2014-077650
Apr. 14, 2014 (JP) 2014-082701

(51) Int. Cl. H01F 27/30; H01F 27/06; H01F 27/24; H01F 27/02

(52) U.S. Cl. CPC H01F 27/306; H01F 27/02; H01F 27/06; H01F 27/24

(57) ABSTRACT

A coil fixation structure includes a coil that a conductive wire is wound around a toroidal core, an arrangement member having a planar arrangement part on which the coil is arranged, a housing configured to accommodate the arrangement member, and an axle part projecting from the arrangement part. The coil is fixed on the arrangement part under condition that the axle part is inserted through a center part of the coil.

### CROSS REFERENCE TO RELATED APPLICATIONS

The present application is based on, and claims priority from Japanese Patent Applications No. 2014-077650, filed Apr. 4, 2014, and No. 2014-082701, filed Apr. 14, 2014, the disclosure of all of which is hereby incorporated by reference herein in its entirety.

### TECHNICAL FIELD

The present application relates to a coil fixation structure. Concretely, the present application relates to a coil fixation structure in a constitution where a coil is arranged on a planar arrangement part of an arrangement member.

### BACKGROUND

As a coil fixation structure in a conventional example, there is known a coil fixation structure including a coil having a conductive wire wound around a toroidal core, a printed substrate as an arrangement member having a planar arrangement part on which the coil is arranged, and a housing accommodating the printed substrate (refer to JP 2008-140801 A).

In the conventional coil fixation structure, both ends of the conductive wire wound around the toroidal core of the coil are soldered to a wiring pattern formed on the printed substrate. The coil is secured on the printed substrate with use of adhesive agent applied to one of both soldered ends of the conductive wire.

### SUMMARY

In the conventional coil fixation structure where the coil is fixed to a planar arrangement part of the arrangement member by means of soldering and adhesive agent, however, if the coil is subjected to vibration transferred on the arrangement part, its stress may concentrate on the soldering or adhesive agent, causing poor connection reliability due to fracture of the conductive wire, occurrence of cracks in the soldering, or the like.

Therefore, an object of the present application is to provide a coil fixation structure which is capable of fixing a coil to an arrangement member stably, thereby improving connection reliability of the coil.

A coil fixation structure according to an aspect of the invention includes a coil that a conductive wire is wound around a toroidal core, an arrangement member having a planar arrangement part on which the coil is arranged, a housing configured to accommodate the arrangement member, and an axle part projecting from the arrangement part. The coil is fixed on the arrangement part under condition that the axle part is inserted through a center part of the coil.

As the coil is fixed on the arrangement part under condition that the axle part is inserted through the center part of the coil, the coil is supported by the axle part, so that the coil can be positioned on the arrangement part.

For this reason, even if the coil is subjected to external force due to vibration or the like, there is no possibility that the coil moves on the arrangement part. As a result, it is possible to prevent the conductive wire of the coil and lead wires connected to the conductive wire from being broken, so that the connection reliability of the coil can be improved.

In such a coil fixation structure therefore, it is possible to stably fix the coil on the arrangement member by fixing the coil by the axle part of the arrangement member, so that the connection reliability of the coil can be improved.

The axle part may be inserted through the center part of the coil by press-fitting.

As the axle part is inserted through the center part of the coil by press-fitting, it is possible to make the coil non-rotatable to the axle part depending on the setting of the outer diameter of the axle part and the inner diameter of the center part of the coil and thus, there is no need of providing an engagement part etc. on the outer circumference of the axle part or the inner circumference of the center part of the coil.

The housing may be provided with an axle locking part which engages with an end of the axle part to lock the axle part.

Owing to the provision of the housing with the axle locking part which engages with the end of the axle part to lock the axle part, when external force is applied to the coil, it is possible to release the external force since it is transmitted to the housing through the axle part, so that the connection reliability for the coil can be improved furthermore.

The housing may be provided with a coil locking part which engages with an external face of the coil to lock the coil.

Owing to the provision of the housing with the coil locking part which engages with the external face of the coil to lock the coil, it is possible to enforce the axle part as well as the fixation of the coil by the coil locking part.

The external shape of the axle part may have a portion, of which distance from a center of the axle part to the outer circumference of the portion is different from the same distance of the other outer circumferential area.

Since the external shape of the axle part has the portion, of which distance from the center to the outer circumference of the portion is different from the same distance of the other circumferential area, the external shape of the axle part does not become a perfect circle and thus, it is possible to make the coil non-rotatable to the axle part because the portion, of which distance from the center to the outer circumference of the portion is different from the same distance of the other circumferential area, engages with the inner circumference of the center part of the coil.

The axle part may have a tip divided to a plurality of flexible pieces. The axle part may have locking pieces arranged at respective tips of the flexible pieces, the locking piece being locked to a periphery of the center part of the coil on the side of a coil's end face opposite to the other coil's end face opposed to the arrangement part under a fitting condition that the coil is fitted to the axle part by inserting the flexible pieces through the center part of the coil.

With such a constitution, when fitting the coil to the axle part, the locking pieces at respective tips of the flexible pieces of the axle part inserted through the center part of the coil are locked to the periphery of the through-hole on one of two end faces of the coil, the one end face being opposite to the other end face opposed to the arrangement part of the arrangement member.

Then, as the locking piece of each flexible piece is locked to an end face portion of the periphery of the center part of the coil, the relative movement of the coil in relation to the arrangement member is suppressed in the direction along the center axis of the coil.

Therefore, even a weighted coil could be fixed to the arrangement member stably.

The coil fixation structure may further include a press-fitting part arranged in a base portion of the axle part and also press-fitted to the center part of the coil under the fitting condition.

With such a constitution, when fitting the coil to the axle part, the locking piece of each flexible piece is locked to the periphery of the center part of the coil and additionally, the press-fitting part is press-fitted to the center part of the coil.

Then, due to frictional force produced between the center part of the coil and the axle part by press-fitting of the axle part to the center part of the coil, the relative movement of the coil in relation to the arrangement member in the circumferential direction of the center part of the coil and the relative movement of the coil in relation to the arrangement member along the center axis of the coil are suppressed respectively. For this reason, it is possible to fix the coil to the arrangement member more stably.

The axle part may further include pressure-contact parts arranged on the flexible pieces respectively and also configured to make pressure contact with an inner wall of the center part of the coil under the fitting condition.

With such a constitution, when fitting the coil to the axle part, the locking piece of each flexible piece is locked to the periphery of the center part of the coil and additionally, the pressure-contact part of the axle part is brought into pressure contact with the inner wall of the center part of the coil.

Then, due to frictional force produced between the center part of the coil and the axle part by pressure contact of the pressure-contact part of each flexible piece with the inner circumferential face of the center part of the coil, the relative movement of the coil in relation to the arrangement member in the circumferential direction of the center part of the coil and the relative movement of the coil in relation to the arrangement member along the center axis of the coil are suppressed respectively. For this reason, it is possible to fix the coil to the arrangement member more stably.

The housing may include a cover having an inner wall which is opposed to the tip of axle part under an accommodating condition that the arrangement member is accommodated in the housing. The cover may include a wedge piece which is formed to stand on the inner wall of the cover and also inserted between the respective flexible pieces under the accommodating condition to expand the flexible pieces apart from each other outwardly. In the arrangement member under the fitting condition, the pressure-contact parts may be formed by portions of the flexible pieces expanded outwardly by the wedge piece, the portions being configured to make pressure contact with the inner wall of the center part of the coil.

With such a constitution, when accommodating the arrangement member with the coil fitted to the axle part in the housing, the respective flexible pieces of the axle part are expanded outwardly by the wedge piece standing on the inner wall of the cover of the housing.

Then, parts of the so-expanded flexible piece make pressure contact with the inner circumferential face of the center part of the coil to function as the pressure-contact part and additionally, the locking pieces of the expanded flexible pieces are locked to the peripheral part of the center part of the coil respectively.

Thus, since the wedge piece of the cover is inserted between the flexible pieces in the process of accommodating the arrangement member with the coil fitted to the axle part in the housing, the respective flexible pieces are expanded outward forcibly. As a result, it is possible to realize the pressure contact of the pressure-contact part and the locking of the locking pieces in relation to the coil surely.

With the aspect according the present invention, it is possible to provide a coil fixation structure which is capable of fixing the coil to the arrangement member stably, thereby improving the connection reliability of the coil.

### BRIEF DESCRIPTION OF DRAWINGS

FIG. 1 is an exploded perspective view of a coil fixation structure according to a first embodiment.

FIG. 2 is a top view of the coil fixation structure according to the first embodiment, illustrating a cross section of a portion of a housing of the coil fixation structure.

FIG. 3 is a perspective view when assembling coils of the coil fixation structure according to the first embodiment to an arrangement member.

FIG. 4 is a perspective view when the arrangement member of the coil fixation structure according to the first embodiment to the housing.

FIG. 5 is a top view of the coil fixation structure according to the first embodiment when engaging an axle part of the structure with an axle locking part, illustrating a cross section of the portion of housing.

FIG. 6 is a top view of the coil fixation structure according to the first embodiment after engaging the axle part of the structure with the axle locking part, illustrating a cross section of the portion of housing.

FIG. 7 is a sectional view of the coil fixation structure according to the first embodiment when engaging the coil of the structure with a coil locking part.

FIG. 8 is a sectional view of the coil fixation structure according to the first embodiment after engaging the coil of the structure with the coil locking part.

FIG. 9A is a top view of the axle part of the coil fixation structure according to the first embodiment, illustrating a protrusion provided on an outer circumference of the axle part, FIG. 9B is a top view of the axle part of the coil fixation structure according to the first embodiment, illustrating a groove provided on the outer circumference of the axle part, and FIG. 9C is a top view of the axle part of the coil fixation structure according to the first embodiment, illustrating unevenness parts provided on the outer circumference of the axle part.

FIG. 10A is a top view of the axle part of the coil fixation structure according to the first embodiment, illustrating the axle part having an external shape with a triangular configuration, FIG. 10B is a top view of the axle part of the coil fixation structure according to the first embodiment, illustrating the axle part having an external shape with a rectangular configuration, and FIG. 10C is a top view of the axle part of the coil fixation structure according to the first embodiment, illustrating the axle part having an external shape with a pentagonal configuration.

FIG. 11 is an exploded perspective view of a coil fixation structure according to a second embodiment.

FIG. 12 is a side view illustrating a schematic constitution of a first terminal part illustrated in FIG. 11.

FIG. 13 is a sectional view illustrating an axle part of an arrangement member before fitting a coil illustrated in FIG. 11.

FIG. 14 is a sectional view illustrating the axle part of the arrangement member after fitting the coil illustrated in FIG. 11.

FIG. 15 is an exploded perspective view of a coil fixation structure according to a third embodiment.

FIG. 16 is a sectional view illustrating an axle part of an arrangement member before fitting a coil illustrated in FIG. 15.

FIG. 17 is a sectional view illustrating the axle part of the arrangement member after fitting the coil illustrated in FIG. 15.

### DETAILED DESCRIPTION

Hereinafter, coil fixation structures according to embodiments will be described with reference to the drawings. Each of the coil fixation structures of the embodiments is applied to a choke coil unit which is used as a noise filter in a circuit with higher current of a vehicle, such as electric vehicle (EV) or hybrids vehicle (HEV: vehicle equipped with an engine and a motor generator).

### First Embodiment

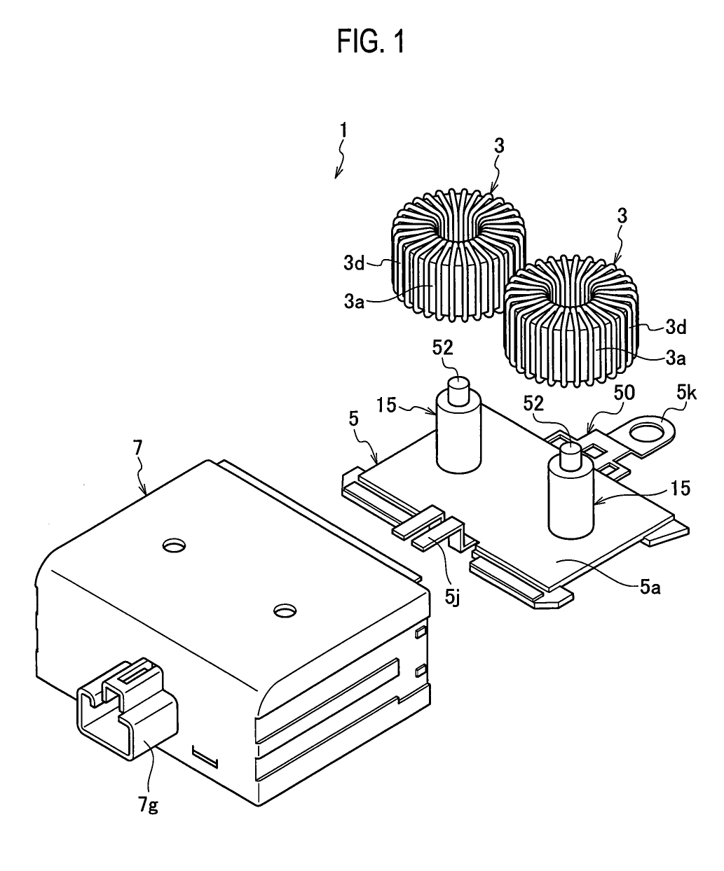

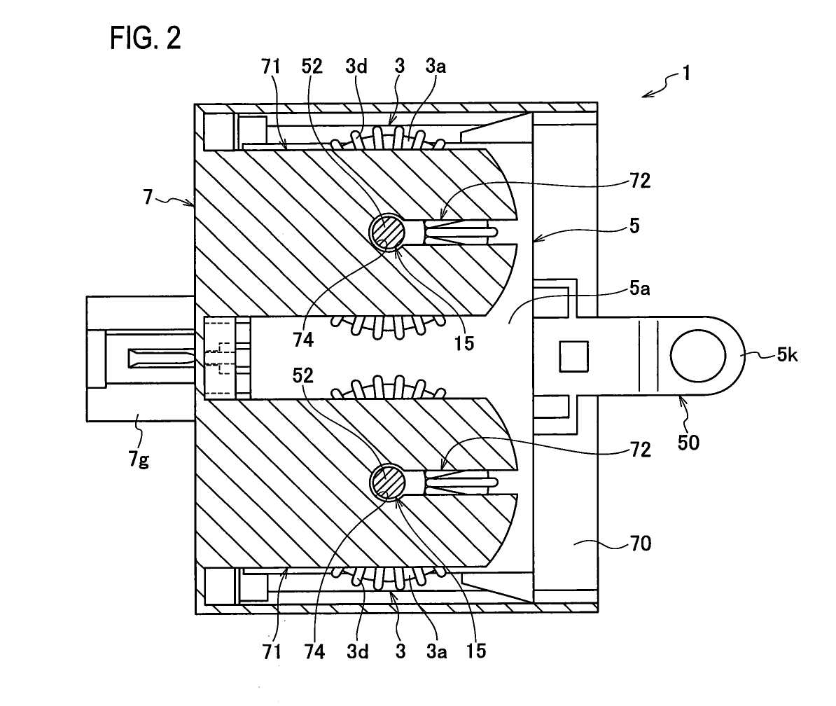

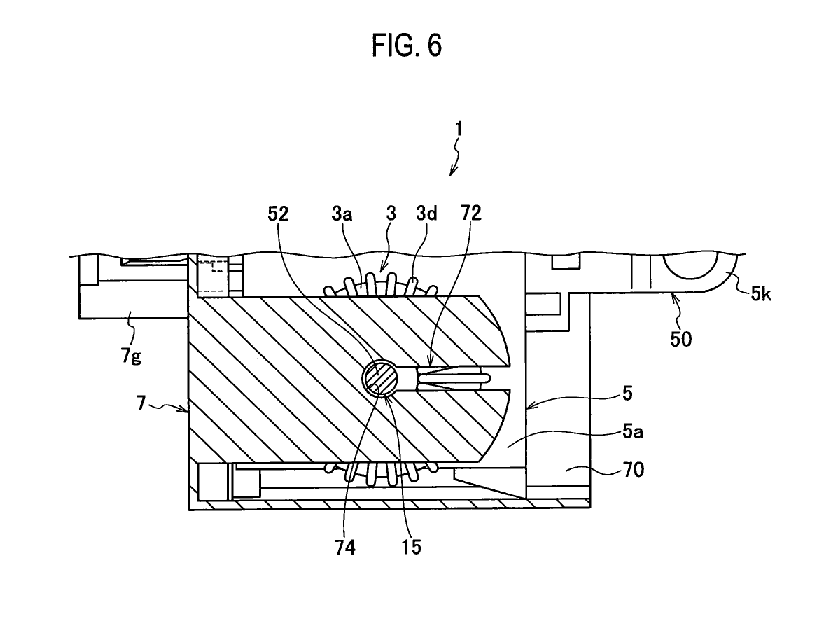

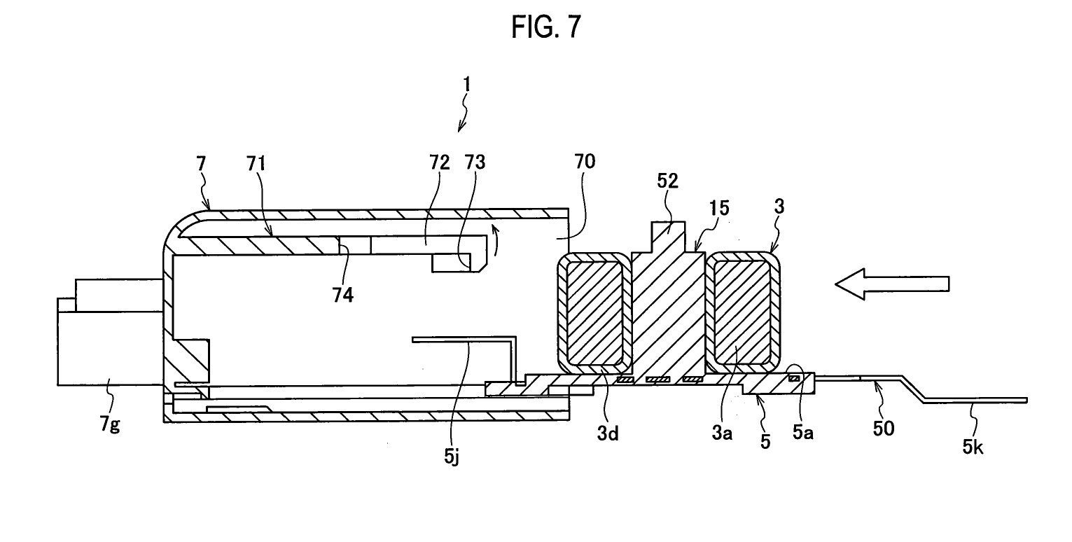

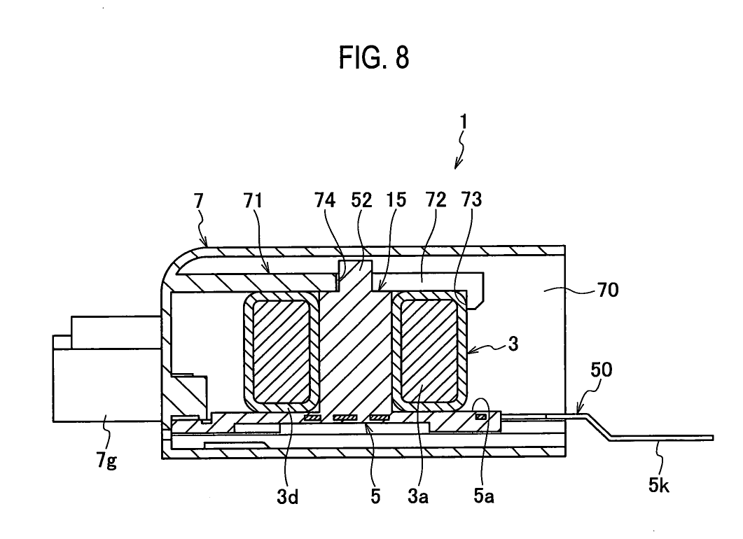

With reference to FIGS. 1 to 10, a coil fixation structure 1 according to a first embodiment will be described.

The coil fixation structure 1 according to the first embodiment includes coils 3 each in which a conductive wire 3d is wound around a toroidal core 3a, an arrangement member 5 having a planar arrangement part 5a on which the coils 3 are arranged, and a housing 7 accommodating the arrangement member 5.

Axle parts 15 are formed so as to project from the arrangement part 5a. The coils 3 are fixed on the arrangement part 5a under condition that the axle parts 15 are inserted through respective center parts of the coils 3.

The axle parts 15 are inserted into the center parts of the coils 3 under press fit condition.

The housing 7 is provided with axle locking parts 72 which engage with respective ends of the axle parts 15 to lock the axle parts 15.

The housing 7 is also provided with coil locking parts 73 which engage with respective external face of the coils 3 to lock the coils 3

Each toroidal core 3 is made from magnetic material and shaped annularly. Each conductive wire 3d is made from conductive material. In the coil 3, the conductive wire 3d is wound around the toroidal core 3a by a predetermined number of turns.

A plurality of (two in this embodiment) coils 3 are arranged on the arrangement part 5a. Both ends of the conductive wire 3a of each coil 3 are electrically connected to a conductor part 50 of the arrangement member 5 through lead wires (not illustrated).

The arrangement member 5 is made out since the conductor part 50 made of conductive material, such as a busbar, is insert-molded in insulating material, such as synthetic resin. The arrangement member 5 includes the arrangement part 5a and the axle parts 15.

The conductor part 50 includes a first terminal part 5j and a second terminal part 5k. The first terminal part 5j forms a connecting part to be connected to a mating terminal (not illustrated) accommodated in a connector connected to wires or the like. The second terminal part 5k forms a connecting part to be connected to an instrument, a power source or the like directly.

The arrangement part 5a is made from insulating material and shaped planarly on one side of the arrangement member 5. The coils 3 are arranged on the arrangement part 5a. On the arrangement part 5a, the plurality of (two in this embodiment) axle parts 15 are formed so as to project toward a direction perpendicular to the in-plane direction.

Each axle part 15 is made from insulating material and shaped to be columnar. The axle part 15 is one member integral with the arrangement part 5a and projecting from the surface of the arrangement part 5a. An engagement part 52 is formed on an end of each axle part 15. The engagement part 52 is column-shaped with an outer diameter smaller than that of an axle's base part on the side of the arrangement part 5a.

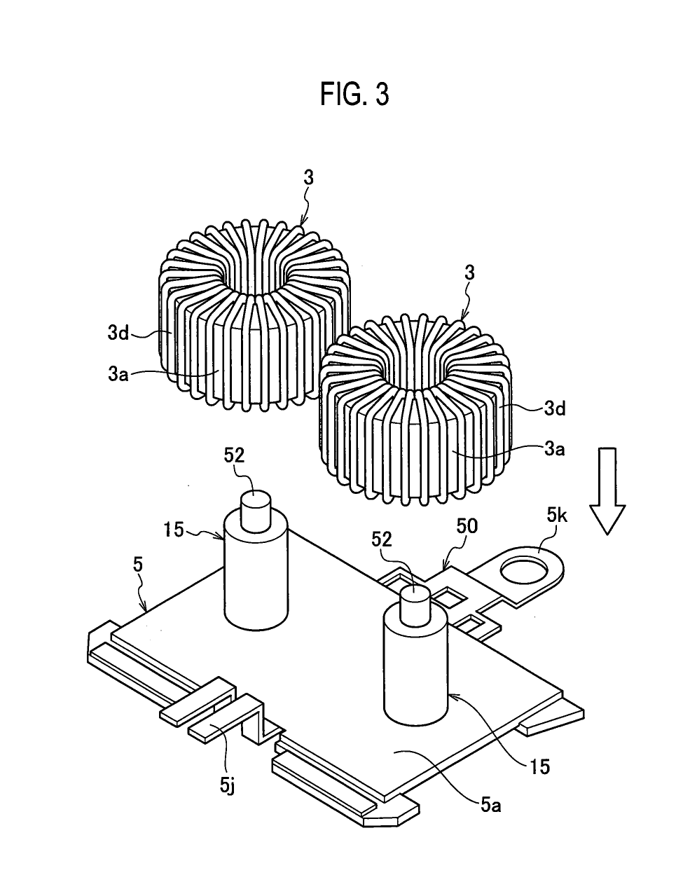

When arranging the coils 3 above the arrangement part 5a, as illustrated with arrow of FIG. 3, the axle parts 15 are press-fitted into the center parts of the coils 3 so as to be inserted through the center parts of the coils 3. Thus, the coils 3 are positioned and fixed on the arrangement part 5a in a non-rotatable manner.

In this way, by press-fitting the coils 3 onto the axle parts 15 and further positioning them on the arrangement part 5a for fixation, even if an external force due to vibration or the like is applied to the coils 3, there is no possibility that the coils 3 move on the arrangement part 5a and the coils 3 rotate about the axle parts 15 as the centers.

Thus, it is possible to reduce burden on lead wires (not illustrated) connected to both ends of the conductive wire 3 of each coil 3 remarkably, so that the connection reliability between the coils 3 and the arrangement member 4 can be improved. In this way, the arrangement member 5 is accommodated inside the housing 7 while the coils 3 are being fixed to the axle parts 15.

The housing 7 is made from insulating material, such as synthetic resin, and shaped in the form of a casing. The housing 7 is provided, on one side face, with an opening 70 capable accommodating the arrangement member 5. A connector part 7g is formed on the other side face of the housing 7. The first terminal part 5j is arranged in the connector part 7g. The second terminal part 5k is exposed to an outside through the opening 70.

In the housing 7, engagement arms 71 capable of deflecting in the height direction of the housing 7 are formed so as to extend in the length direction of the housing 7 in a cantilever condition. Each engagement arm 71 is provided with an axle locking part 72 and a coil locking part 73.

The axle locking part 72 is provided in the form of a groove that is obtained by cutting the engagement arm 71 from a free end of the arm 71 toward the base end. The bottom part of the axle locking part 72 forms an engaged part 74 having an inner diameter similar to the outer diameter of the engagement part 52.

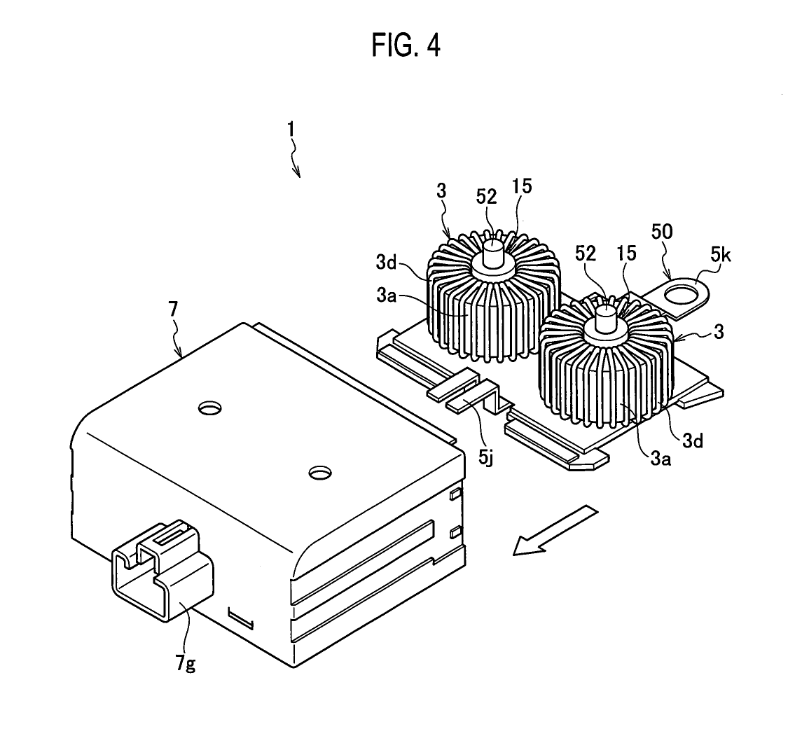

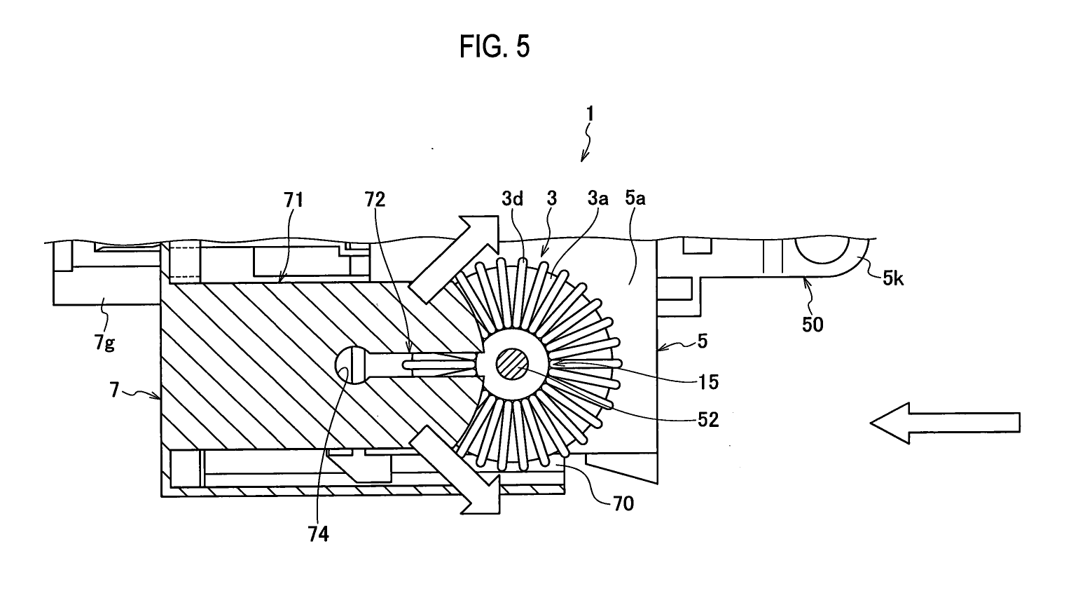

As illustrated with arrows of FIGS. 4 and 5, the engagement parts 52 of the axle parts 15 are inserted into the grooves of the axle locking parts 72 since the arrangement member 5 is accommodated in the housing 7. At this time, a pair of free ends of the engagement arm 71 forming the groove are expanded as illustrated with arrows of FIG. 5.

Then, when the arrangement member 5 is completely accommodated in the housing 7, the engagement parts 52 of the axle parts 15 are engaged with the engaged parts 74 of the axle locking parts 72, so that the axle parts 15 are locked by the axle locking parts 72.

In this way, since each axle locking part 72 of the housing 7 locks each axle part 15 to which the coil 3 is fixed, even if an external force is applied to the coil 3, the external force can be released by transmission of the external force from the axle part 15 to the housing 7, so that it is possible to reduce burden on lead wires (not illustrated) connected to the coil 3.

The coil locking parts 73 are arranged so as to extend toward the free ends of the engagement arms 71 downwardly of the housing 7 and shaped to have L-shaped cross sections.

When each coil locking part 73 comes in contact with the external face of the coil 3 on the way of accommodating the arrangement member 5 in the housing 7, the coil locking part 73 deflects the engagement arm 71 toward the upside of the housing 7.

Then, when the arrangement member 5 is completely accommodated in the housing 7, that is, the engagement parts 52 of the axle parts 15 engage with the engaged parts 74 of the axle locking parts 72, the engagement arms 71 restore toward the underside of the housing 7 and then, the coil locking parts 73 engage with the coils 3 so as to cover the external faces of the coils 3, so that the coils 3 are locked by the coil locking parts 73.

In this way, by locking the coils 3 through the coil locking parts 73, it is possible to prevent the coils 3 from moving on the arrangement part 5a of the arrangement member 5 under condition that the arrangement member 5 is accommodated in the housing 7. Additionally, by providing the coil locking part 31 and the axle locking part 72 in one engagement arm 71, it is possible to reduce the number of components and suppress the scale-up in size of the housing 7.

Next, the method of assembling the coil fixation structure 1 will be described.

First, it is performed to press-fit each coil 3 to the respective axle parts 15 so that the axle parts 15 are inserted through the center parts of the coils 3, from the upside of the arrangement part 5a of the arrangement member 5. Next, the arrangement member 5 where the coils 3 are fixed to the axle parts 15 is inserted into the housing 7 through the opening 70.

Then, the engagement parts 52 of the axle parts 15 are inserted into the axle locking parts 72 to make the engagement parts 52 of the axle parts 15 engage with the engaged parts 74 of the axle locking parts 72 and then, the engagement arms 71 are deflected by the external faces of the coils 3 to make the coil locking parts 73 engage with the external faces of the coils 3 due to restoring forces of the engagement arms 71, thus completing the assembling operation.

In the coil fixation structure 1 according to the first embodiment, the coils 3 are fixed to the arrangement part 5a under the condition that the axle parts 15 are inserted through the center parts of the coils 3. Consequently, the coils 3 can be positioned on the arrangement part 5a while the coils 3 are being supported by the axle parts 15.

For this reason, even if the coils 3 are subjected to external force due to vibration or the like, there is no possibility that the coils 3 move on the arrangement part 5a. As a result, it is possible to prevent the conductive wire 3d of each coil 3 and lead wires (not illustrated) connected to the conductive wire 3d from being broken, so that the connection reliability of the coils 3 can be improved.

Accordingly, in the coil fixation structure 1 according to the first embodiment, the coils 3 can be stably fixed to the arrangement member 5 by fixing the coils 3 through the axle parts 15 of the arrangement member 5, allowing the connection reliability for the coils 3 to be improved.

Additionally, as the axle parts 15 are inserted through the center parts of the coils 3 by press-fitting, it is possible to make the coils 3 non-rotatable to the axle parts 15 depending on the setting of the outer diameter of the axle parts 15 and the inner diameter of the center parts of the coils 3 and thus, there is no need of providing an engagement part etc. on the outer circumference of each axle part 15 or the inner circumference of the center part of each coil 3.

Moreover, the housing 7 is provided with the axle locking parts 72 which engage with the ends of the axle parts 15 to lock the axle parts 15. Thus, when external force is applied to the coils 3, it is possible to release the external force since it is transmitted to the housing 7 through the axle parts 15, so that the connection reliability for the coils can be improved furthermore.

The housing 7 is also provided with the coil locking parts 73 which engage with the external faces of the coils 3 to lock the coils 3. Therefore, it is possible to enforce the axle parts 15 as well as the fixation of the coils 3 by the coil locking parts 73.

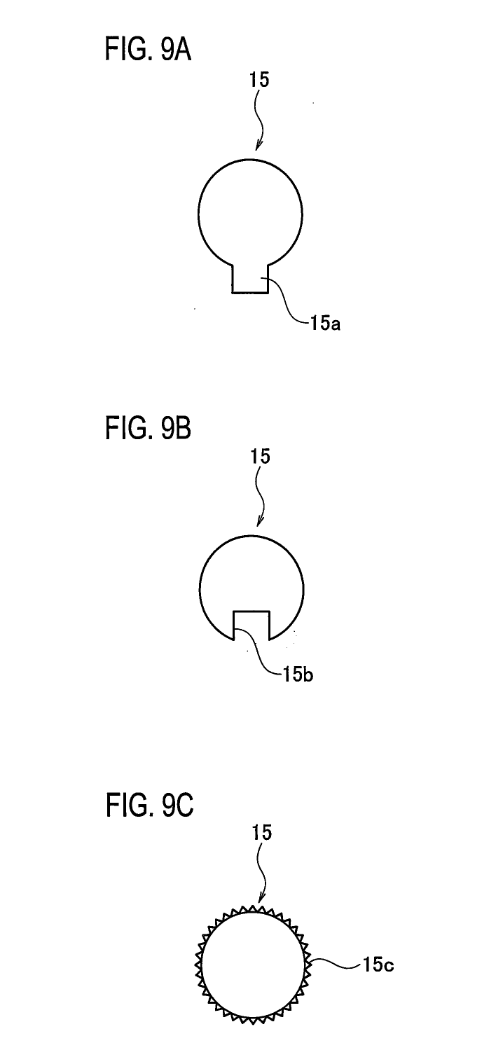

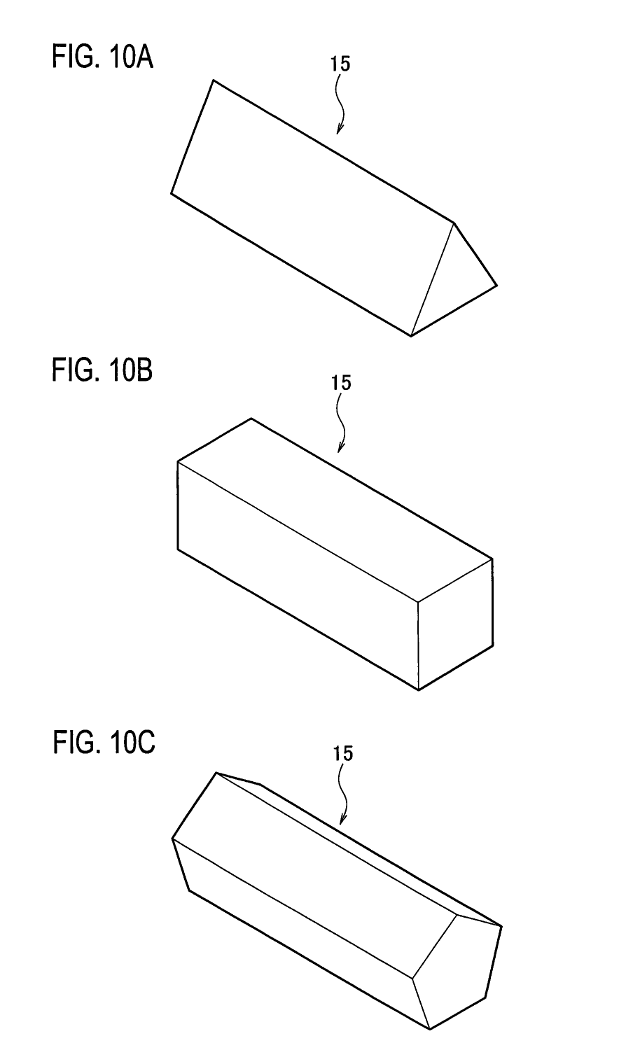

As illustrated in FIGS. 9A to 9C, for example, the axle part 15 may be provided, on an outer circumference of the axle part 15, with a convex part 15a including one ridge projecting along the length direction of the axle part 15, a concave part 15b including one groove formed along the length direction of the axle part 15, or an unevenness part 15c composed of a plurality of ridges or grooves formed along the length direction of the axle part 15. Additionally, as illustrated in FIGS. 10A to 10C for example, the external shape of the axle part 15 may have a polygonal configuration, such as a triangle, rectangle, or pentagon.

Namely, each external shape of the axle parts 15 illustrated in FIGS. 9A to 9C and FIGS. 10A to 10C has a portion, of which distance from the center to the outer circumference of the portion is different from the same distance of the other outer circumferential area. In other words, the external shape of each axle part 15 is established so as to have a shape other than a perfect circle.

Concretely, in the axle parts 15 illustrated in FIGS. 9A to 9C, each of the convex part 15a, the concave part 15b, and the unevenness part 15c forms the portion, of which distance from the center to the outer circumference of the portion is different from the same distance of the other outer circumferential area. In the axle parts 15 illustrated in FIGS. 10A to 10C, each corner of triangle, rectangle, and pentagon forms the portion, of which distance from the center to the outer circumference of the portion is different from the same distance of the other outer circumferential area.

With such an establishment of the external shape of the axle part 15, as the portion, of which distance from the center to the outer circumference of the portion is different from the same distance of the other outer circumferential area, engages with the inner circumference of the center part of the coil or the inner circumference of the axle locking part 72 of the housing 7 in engagement with the end of the axle part 15 in the rotating direction, it is possible to fix the coil 3 to the axle part 15 non-rotatably and also possible to fix the end of the axle part 15 to the axle locking part 72.

Additionally, in this case, by conforming the shape of the center part of the coil 3 through which the axle part 15 is to be inserted or the shape of the axle locking part 72 of the housing 7 in engagement with the end of the axle part 15 to the external shape of the axle part 15, it is possible to enforce the fixation of the coil 3 to the axle part 15 and the fixation of the axle part 15 to the axle locking part 72.

In common with the axle parts 15 illustrated in FIGS. 9A to 9C and FIGS. 10A to 10C, as the external shape of each axle part has a portion, of which distance from the center to the outer circumference of the portion is different from the same distance of the other outer circumferential area, the external shape of each axle part 15 does not become a perfect circle and thus, it is possible to make the coil 3 non-rotatable to the axle part 15 because the portion, of which distance from the center to the outer circumference of the portion is different from the same distance of the other outer circumferential area, engages with the inner circumference of the center part of the coil 3.

Note that although the coils 3 are connected to the conductor parts of the arrangement member 5 through lead wires (not illustrated) in the coil fixation structure 1 according to the first embodiment, the invention is not limited only to this structure and therefore, on the assumption that holes are formed in the insulating material of the arrangement member 5, the conductive wires of the coils may be directly connected to the conductive parts of the arrangement member 5 by means of soldering or the like.

Further, although the axle locking part 72 and the coil locking part 73 are provided in the single engagement arm 71, it is not limited to this and therefore, the axle locking part 72 and the coil locking part 73 may be arranged at separate positions of the housing 7. Additionally, the axle locking part 72 and the coil locking part 73 can have any shape as long as it can lock the axle part 15 or the coil 3.

### Second Embodiment

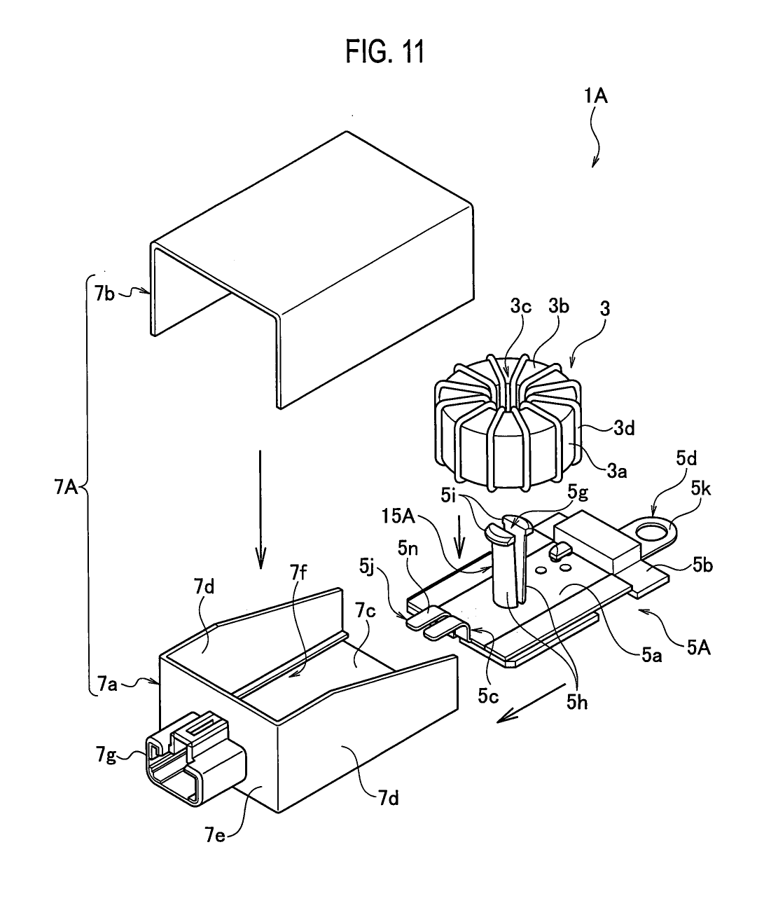

With reference to FIGS. 11 to 14, a coil fixation structure 1A according to a second embodiment will be described.

As illustrated in FIG. 11, the coil fixation structure 1A according to the second embodiment includes a coil 3, an arrangement member 5A on which the coil 3 is mounted, and a housing 7A in which the arrangement member 5A with the mounted coil 3 is accommodated.

The coil 3 is provided by winding a conductive wire 3d around a toroidal core 3a which has a through-hole 3c formed at the center part of an end surface 3b. The coil 3 is mounted on an arrangement part 5a of the arrangement member 5A.

The arrangement member 5A is formed by a metal-core substrate where a first busbar 5c and a second busbar 5d are insert-molded in a resinous member 5b in the form of a rectangular plate. Both long sides of the resinous member 5b is formed with stepped guide parts respectively.

The arrangement part 5a is formed by one side of the resinous member 5b. In the arrangement part 5a, an axle part 15A is formed so as to stand upright by means of integral-molding with the resinous member 5b. The axle part 15A is fitted into the coil 3.

The axle part 15A is formed by a column body capable of penetrating through the through-hole 3c of the toroidal core 3a around which the conductive wire 3d is wound. The base portion (press-fitting part) of the axle part 15A has an outer diameter somewhat larger than the inner diameter of the through-hole 3c of the toroidal core 3a around which the conductive wire 3d is wound, whereas the portion other than the base portion is formed to have an outer diameter less than the inner diameter of the through-hole 3c of the toroidal core 3a around which the conductive wire 3d is wound.

The axle part 15A is divided into two through a radial slit 5g extending to the base, so that resultant respective portions form flexible pieces 5h having flexibility in the radial direction of the axle part 15A. The respective flexible pieces 5h are formed, at their tips, with locking pieces 5i projecting outward in the radial direction of the axle part 15A, respectively.

The height of the flexible piece 5h except for the locking piece 5i, that is, the dimension of the axle part 15A in the direction of a center axis of the part 15A is equal to the dimension of the toroidal core 3a in the direction of a center axis of the core 3a.

In the normal state where the respective flexible pieces 5h are not deflected, the dimension between the respective tips of the locking pieces 5i of the respective flexible pieces 5h in the radial direction of the axle part 15A is longer than the diameter of the through-hole 3c of the toroidal core 3a around which the conductive wire 3d is wound. When deflecting the respective flexible pieces 5h inwardly in the radial direction of the axle part 15A, the dimension between the tips of the locking pieces 5i of the respective flexible pieces 5h in the radial direction of the axle part 15A becomes shorter than the diameter of the through-hole 3c of the toroidal core 3a around which the conductive wire 3d is wound.

In the first busbar 5c and the second busbar 5d, their major portions are embedded in the resinous member 5b, whereas their remaining portions project from respective short sides of the resinous member 5b to form a first terminal part 5j and a second terminal part 5k, respectively.

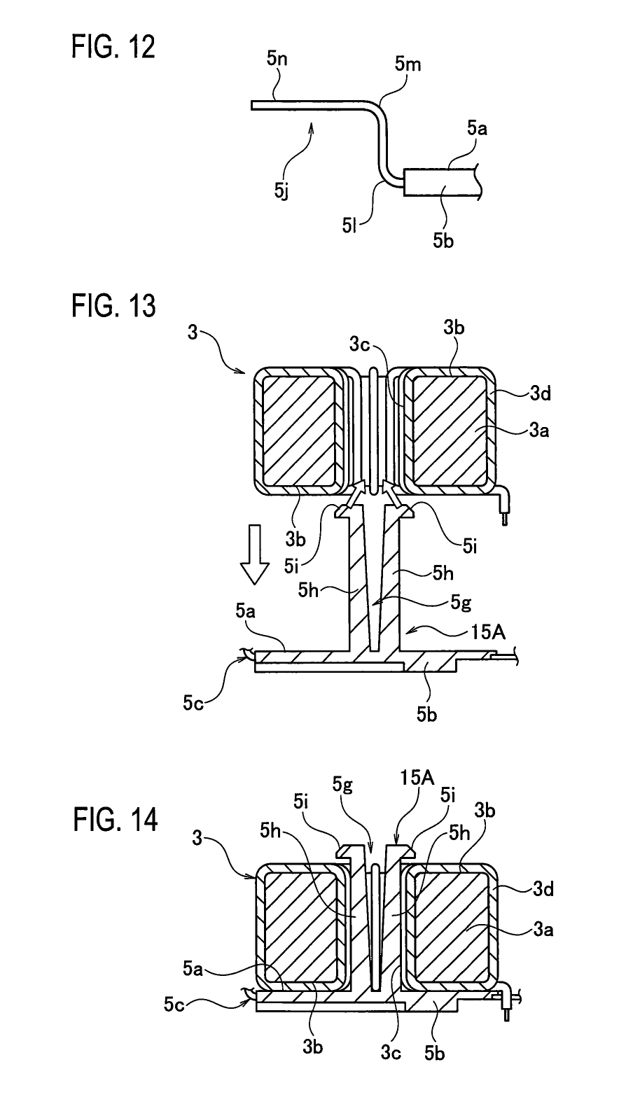

As illustrated in FIG. 12, the first terminal part 5j is crank-shaped with a first bending part 5l and a second bending part 5m. A tip portion 5n of the first terminal part 5j is arranged so as to extend in parallel with the resinous member 5b. The second terminal part 5k includes a screw hole screw-fastened to an earth point (not illustrated) of a vehicle.

Both ends of the conductive wire 3d of the coil 3 fitted to the axle part 15A are electrically connected to the first busbar 5c and the second busbar 5d through capacitors (not illustrated), respectively.

The housing 7A includes a casing 7a for accommodating the arrangement member 5A and a cover 7b for covering an open portion of the casing 7a. The casing 7a includes a bottom plate 7c having a size corresponding to the resinous member 5b of the arrangement member 5A, long side plates 7d standing from both long sides of the bottom plate 7c, and a short side plate 7e standing from one short side of the bottom plate 7c.

On respective inside faces of the long side plates 7d, guide grooves 7f for guiding the guide parts of the resinous member 5b of the arrangement member 5A are formed in parallel with the bottom plate 7c, respectively. A tubular connector part 7g is formed so as to project from the outside face of the short side plate 7e.

Respective heights of the long side plates 7d and the short side plate 7e in the standing direction are all higher than the standing height of the axle part 15A of the arrangement member 5A accommodated in the casing 7a. Respective corners of the long side plates 7d, which are positioned close to the opened short side of the casing 7a, are tapered.

When accommodating the arrangement member 5A in the casing 7a, it is performed to insert the respective guide parts into the respective guide grooves 7f while inserting the first terminal part 5j of the arrangement member 5A into the casing 7a through the opened short side. When the insertion is advanced till one short side of the resinous member 5b abuts on the short side plate 7e, the arrangement member 5A is accommodated in the casing 7a. When the arrangement member 5A is accommodated in the casing 7a, the tip portion 5n of the first terminal part 5j of the arrangement member 5A penetrates through a through-hole (not illustrated) of the short side plate 7e and becomes exposed to the inside of the connector part 7g.

The cover 7b is formed in a shape whose lower sides and one short side are both opened, so that the opened one short side and upper sides of the casing 7a can be covered by the cover 7b placed over the casing 7a.

Next, the procedure for mounting the coil 3 on the arrangement member 5A will be described. First, while deflecting the flexible pieces 5h of the axle part 15A of the arrangement member 5A inwardly in the radial direction of the axle part 15A from the condition illustrated in FIG. 13, the axle part 15A is inserted into the through-hole 3c of the toroidal core 3a around which the conductive wire 3d is wound.

When the axle part 15A is fully inserted into the through-hole 3c, the locking pieces 5i of the flexible pieces 5h penetrate through the through-hole 3c. As soon as the locking pieces 5i penetrate through the through-hole 3c, the flexible pieces 5h deflected inwardly in the radial direction of the axle part 15A are restored outwardly due to their elastic force. The locking pieces 5i of the restored flexible pieces 5h are locked to a peripheral portion of the through-hole 3c at one end face 3b of the toroidal core 3a opposite to the other end face 3b opposed to the arrangement part 5a of the arrangement member 5A, as illustrated in FIG. 14.

Additionally, when the axle part 15A is fully inserted into the through-hole 3c of the toroidal core 3a around which the conductive wire 3d is wound, the conductive wire 3d wound around the toroidal core 3a abuts on the arrangement part 5a, on the side of the other end face 3b opposed to the arrangement part 5a of the arrangement member 5A.

Thus, the coil 3 is fitted to the axle part 15A of the arrangement member 5A. As the fitted coil 3 is locked to the end faces 3b of the locking pieces 5i, the relative movement of the coil 3 in relation to the arrangement member 5A is suppressed in the direction along the center axis of the toroidal core 3a.

Further, when the coil 3 is fitted to the axle part 15A of the arrangement member 5A, there is realized a press-fitting condition that the base portions of the flexible pieces 5h are press-fitted into the through-hole 3c of the toroidal core 3a around which the conductive wire 3d is wound, since the outer diameter of the base portion of the axle part 15A is somewhat larger than the inner diameter of the through-hole 3c of the toroidal core 3a around which the conductive wire 3d is wound. Due to frictional force between the through-hole 3c and the axle part 15A resulting from this press-fitting, the relative movement of the mounted coil 3 in relation to the arrangement member 5A is suppressed in the direction along the center axis of the toroidal core 3a and also in the circumferential direction.

Moreover, when the coil 3 is fitted to the axle part 15A of the arrangement member 5A so that the locking pieces 5i penetrate through the through-hole 3c and the flexible pieces 5h are restored outwardly due to elastic force, there is realized a pressure-contact condition that the outer circumferential faces (pressure-contact parts) of the flexible pieces 5h come into contact with the inner circumferential face of the through-hole 3c of the toroidal core 3a around which the conductive wire 3d is wound, under pressure. Also due to frictional force between the toroidal core 3a and the axle part 15A resulting from this pressure-contact, the relative movement of the mounted coil 3 in relation to the arrangement member 5A is suppressed in the direction along the center axis of the toroidal core 3 and also in the circumferential direction.

After fitting the coil 3 to the axle part 15A, both ends of the conductive wire 3d of the coil 3 are electrically connected to the first busbar 5c and the second busbar 5d, respectively. In this way, the coil 3 is mounted on the arrangement member 5A.

After mounting the coil 3 on the arrangement member 5A in accordance with the above-mentioned procedure, as mentioned previously, the arrangement member 5A is accommodated in the casing 7a of the housing 7A and thereupon, the cover 7b is attached to the casing 7a, completing the coil fixation structure 1A.

In the coil fixation structure 1A according to the second embodiment, the relative movement of the coil 3 fitted to the axle part 15 in relation to the arrangement member 5A is suppressed in the direction along the center axis of the toroidal core 3a and in the circumferential direction. Thus, even when a weighted component has to be used in the coil 3 for the specifications corresponding to noise to be filtered, it is possible to mount and fix the coil 3 to the arrangement member 5A stably.

In the coil fixation structure 1A according to the second embodiment, by establishing the outer diameter of the base portion of the axle part 15A which is somewhat larger than the inner diameter of the through-hole 3c of the toroidal core 3a around which the conductive wire 3d is wound, there is realized a constitution that the base portions of the flexible pieces 5h come into contact with the inner circumferential face of the through-hole 3c when the coil 3 is fitted to the axle part 15A.

Nevertheless, the constitution for making the flexible pieces 5h in pressure-contact with the through-hole 3c of the coil 3 fitted to the axle part 15A may be different from the coil fixation structure 1A according to the second embodiment.

### Third Embodiment

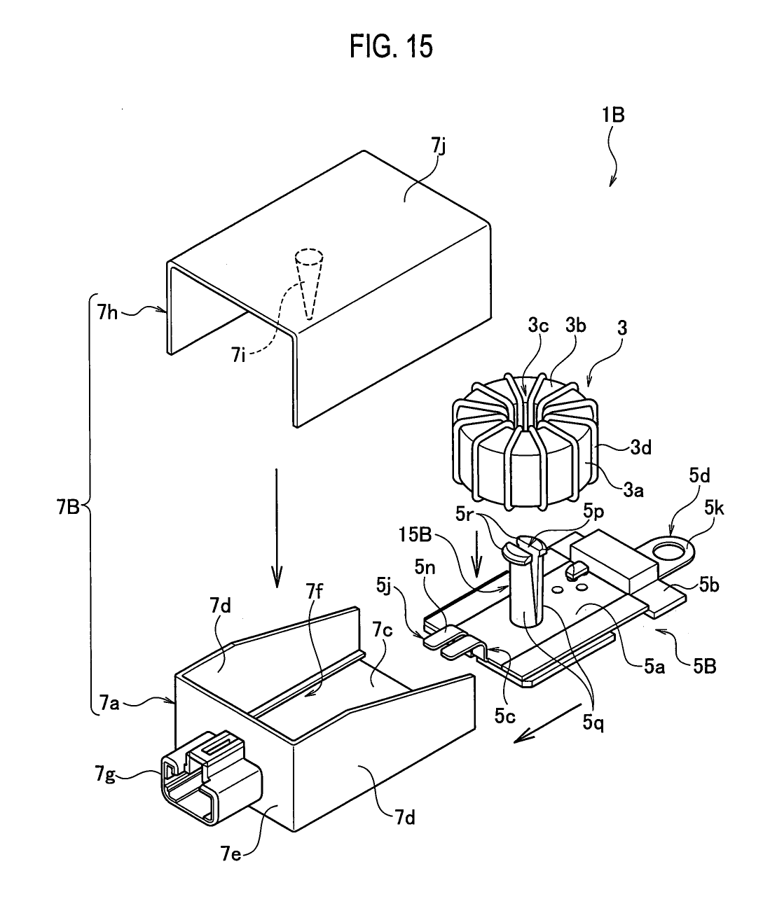

With reference to FIGS. 15 to 17, a coil fixation structure 1B according to a third embodiment will be described.

As illustrated in FIG. 15, the coil fixation structure 1B according to the third embodiment includes a coil 3 similar in constitution to the coil fixation structure 1A according to the second embodiment, and an arrangement member 5B and a housing 7B both different in constitution from the coil fixation structure 1A according to the second embodiment.

In the arrangement member 5B, the constitution of an axle part 15B is different from that of the axle part 15A of the arrangement member 5A according to the second embodiment, whereas respective parts other than the axle part 15B of the arrangement member 5B are constructed similarly to the respective parts of the arrangement member 5A according to the second embodiment.

The axle part 15B is formed by a column body capable of penetrating through the through-hole 3c of the toroidal core 3a around which the conductive wire 3d is wound and additionally, the axle part is formed with an outer diameter less than the inner diameter of the through-hole 3c of the toroidal core 3a around which the conductive wire 3d is wound.

Similarly to the axle part 15A according to the second embodiment, the axle part 15B is divided into two through a radial slit 5p extending to the base, so that resultant respective portions form flexible pieces 5q having flexibility in the radial direction of the axle part 15B. The respective flexible pieces 5q are formed, at their tips, with locking pieces 5r projecting outward in the radial direction of the axle part 15B, respectively.

Note, the height of the flexible piece 5q except for the locking piece 5r, that is, the dimension of the axle part 15B in the direction of a center axis of the part 15B is equal to the dimension of the toroidal core 3a in the direction of a center axis of the core 3a.

In the normal state where the respective flexible pieces 5q are not deflected, the dimension between the respective tips of the locking pieces 5r of the respective flexible pieces 5q in the radial direction of the axle part 15B is shorter than the diameter of the through-hole 3c of the toroidal core 3a around which the conductive wire 3d is wound.

The housing 7B includes a casing 7a similar to that of the housing 7A according to the second embodiment and a cover 7h different in constitution from that of the housing 7A according to the second embodiment. The cover 7h is provided by adding a wedge piece 7i to the interior side of the cover 7b of the housing 7A according to the second embodiment.

The wedge piece 7i is formed so as to project from an inside face (inner wall) of a top plate 7j, which is opposed to the axle part 15A of the arrangement part 5a of the arrangement member 5B under condition of attaching the cover 7h to the casing 7a accommodating the arrangement member 5B where the coil 3 is fitted to the axle part 15A.

The wedge piece 7i is formed into the shape of a tapered cone. The outer diameter of the wedge piece 7i on the side of a piece's base is larger than an interval of the flexible pieces 5q (width of the slit 5p) of the axle part 15B of the arrangement member 5B, whereas the outer diameter on the side of a piece's tip is smaller than the interval of the flexible pieces 5q (width of the slit 5p). The wedge piece 7i is inserted into the slit 5p of the axle part 15B under condition of attaching the cover 7h to the casing 7a accommodating the arrangement member 5B where the coil 3 is fitted.

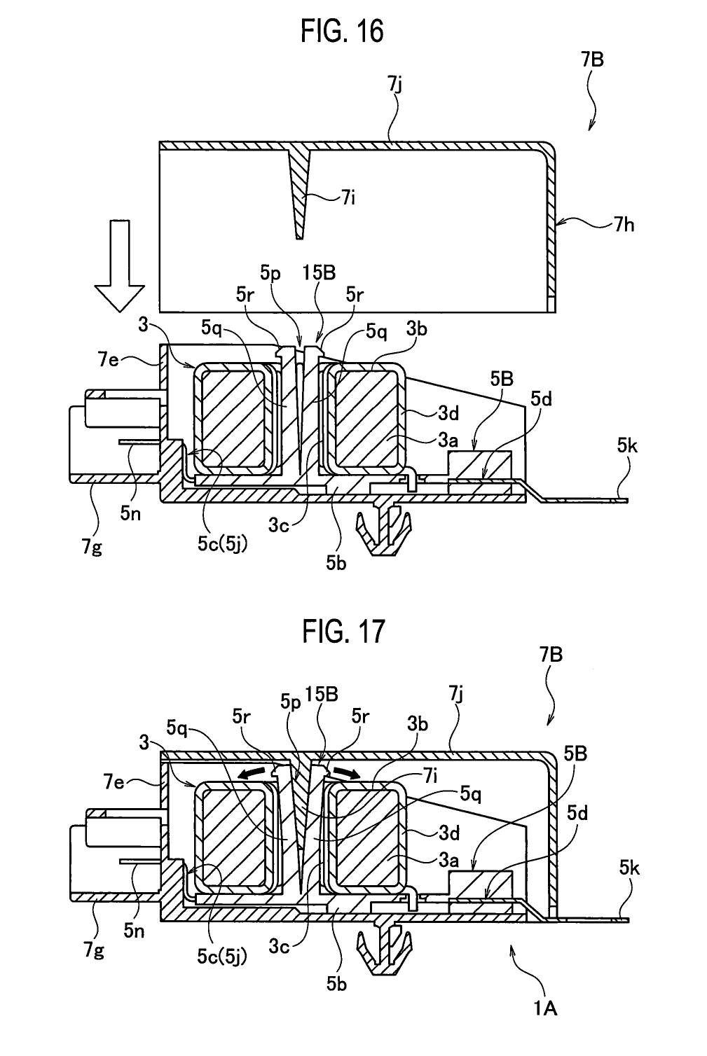

Next, the procedure for mounting the coil 3 on the arrangement member 5B will be described. First, the flexible pieces 5q of the axle part 15B of the arrangement member 5B are inserted onto the through-hole 3c of the toroidal core 3a around which the conductive wire 3d is wound. When the axle part 15B is fully inserted into the through-hole 3c, locking pieces 5r of the flexible pieces 5q penetrate through the through-hole 3c, as illustrated in FIG. 16. In this way, the coil 3 is fitted to the axle part 15B of the arrangement member 5B. After fitting the coil 3 to the axle part 15B, both ends of the conductive wire 3d of the coil 3 are electrically connected to the first busbar 5c and the second busbar 5d, respectively.

In succession, with the same procedure as for accommodating the arrangement member 5A in the casing 7a of the housing 7A in the second embodiment, the arrangement member 5B is accommodated in the casing 7a of the housing 7B and thereupon, the cover 7h is attached to the casing 7a so as to cover the opened short side and upper sides of the casing 7a.

When attaching the cover 7h to the casing 7a, the wedge piece 7i of the cover 7h is inserted into the slit 5p of the axle part 15B, so that the flexible pieces 5q of the axle part 15 are deflected and expanded outwardly in the radial direction of the axle part 15B. Due to this expansion, there is realized a pressure-contact condition that the outer circumferential faces (pressure-contact parts) of the flexible pieces 5q come into contact with the inner circumferential face of the through-hole 3c of the toroidal core 3a around which the conductive wire 3d is wound, under pressure.

When the flexible pieces 5q are expanded outwardly in the radial direction of the axle part 15B till they come in contact with the inner circumferential face of the through-hole 3c under pressure, the dimension between the respective tips of the locking pieces 5r of the flexible pieces 5q in the radial direction of the axle part 15B gets larger than the outer diameter of the through-hole 3c of the toroidal core 3a around which the conductive wire 3d is wound. Thus, under the above-mentioned pressure-contact condition of the flexible pieces 5q to the through-hole 3c, the locking pieces 5r of the flexible pieces 5q are locked to a peripheral portion of the through-hole 3c at one end face 3b of the toroidal core 3a opposite to the other end face 3b opposed to the arrangement part 5a of the arrangement member 5B, as illustrated in FIG. 17.

Consequently, there is realized a condition that the coil 3 is fitted to the axle part 15B of the arrangement member 5B and also mounted on the arrangement member 5B. As the coil 3 mounted on the arrangement member 5B is locked to the end face 3b of the locking pieces 5r, the relative movement of the coil 3 in relation to the arrangement member 5B is suppressed in the direction along the center axis of the toroidal core 3a.

Due to frictional force between the toroidal core 3a and the axle part 15B resulting from the pressure-contact of the flexible pieces 5q against the inner circumferential face of the through-hole 3c, the relative movement of the mounted coil 3 in relation to the arrangement member 5B is suppressed in the direction along the center axis of the toroidal core 3a and also in the circumferential direction.

When attaching the cover 7h to the casing 7a of the housing 7A and also mounting the coil 3 on the arrangement member 7B in the above-mentioned way, there is realized a condition that the coil fixation structure 1B is completed.

Also, in the coil fixation structure 1B according to the third embodiment, the relative movement of the coil fitted to the axle part 15B in relation to the arrangement member 5B is suppressed in the direction of the center axis of the toroidal core 3a and in the circumferential direction. Thus, even when a weighted component has to be used in the coil 3 for the specifications corresponding to noise to be filtered, it is possible to mount and fix the coil 3 to the arrangement member 5B stably.

In the coil fixation structure 1A according to the second embodiment, by allowing the base portions of the flexible pieces 5h of the axle part 15A to have an outer diameter somewhat larger than the inner diameter of the through-hole 3c of the toroidal core 3a, there is realized a constitution that the base portions of the flexible pieces 5h are press-fitted to the through-hole 3c when the coil 3 is fitted to the axle part 15A. However, it is noted that this constitution may be omitted.

Conversely, the constitution of the third embodiment may be modified so that the base portions of the flexible pieces 5q are press-fitted to the through-hole 3c when the coil 3 is fitted to the axle part 15B, provided that the base portion of the flexible pieces 5q of the axle part 15B has an outer diameter somewhat larger than the inner diameter of the through-hole 3c of the toroidal core 3a.

In the second and third embodiments, additionally, there is realized a constitution that when the coil 3 is fitted to the axle part 15A (15B), the outer circumferential faces of the respective flexible pieces 5h (5q) of the axle part 15A (15B) come in contact with the inner circumferential face of the through-hole 3c of the toroidal core 3a under pressure. However, it is noted that this constitution may be omitted.

Note, in the above-mentioned embodiments, the application of the coil fixation structure to a choke coil unit used in a vehicle, such as electric vehicle (EV) or hybrids vehicle (REV: vehicle equipped with an engine and a motor generator) has been explained as an example. Nevertheless, the present invention is broadly applicable in providing a coil fixation structure by fixing a coil having a conductive wire wound around a toroidal core on an arrangement member.

What is claimed is:

1. A coil fixation structure, comprising:
a coil that a conductive wire is wound around a toroidal core;
an arrangement member having a planar arrangement part on which the coil is arranged;
a housing configured to accommodate the arrangement member; and
an axle part projecting from the arrangement part, wherein
the coil is fixed on the arrangement part under condition that the axle part is inserted through a center part of the coil.

2. The coil fixation structure of claim 1, wherein
the axle part is inserted through the center part of the coil by press-fitting.

3. The coil fixation structure of claim 1, wherein
the housing is provided with an axle locking part which engages with an end of the axle part to lock the axle part.

4. The coil fixation structure of claim 1, wherein
the housing is provided with a coil locking part which engages with an external face of the coil to lock the coil.

5. The coil fixation structure of claim 1, wherein
an external shape of the axle part has a portion characterized by the distance from a center of the axle part to an outer circumference, which is different from the same distance of the other outer circumferential area.

6. The coil fixation structure of claim 1, wherein
the axle part has a tip divided to a plurality of flexible pieces, and
the axle part has locking pieces arranged at respective tips of the flexible pieces, the locking piece being locked to a periphery of the center part of the coil on the side of a coil's end face opposite to the other coil's end face opposed to the arrangement part under a fitting condition that the coil is fitted to the axle part by inserting the flexible pieces through the center part of the coil.

7. The coil fixation structure of claim 6, further comprising:
a press-fitting part arranged in a base portion of the axle part and also press-fitted to the center part of the coil under the fitting condition.

8. The coil fixation structure of claim 6, wherein
the axle part further comprises pressure-contact parts arranged on the flexible pieces respectively and also configured to make pressure contact with an inner wall of the center part of the coil under the fitting condition.

9. The coil fixation structure of claim 8, wherein
the housing comprises a cover having an inner wall which is opposed to the tip of axle part under an accommodating condition that the arrangement member is accommodated in the housing;
the cover includes a wedge piece which is formed to stand on the inner wall of the cover and also inserted between the respective flexible pieces under the accommodating condition to expand the flexible pieces apart from each other outwardly; and
in the arrangement member under the fitting condition, the pressure-contact parts are formed by portions of the flexible pieces expanded outwardly by the wedge piece, the portions being configured to make pressure contact with the inner wall of the center part of the coil.
